(19) United States
(12) Patent Application Publication
(10) Pub. No.: US 2004/0243487 A1
(43) Pub. Date: Dec. 2, 2004

(54) Vendor-managed inventory system and method

(76) Inventors: Chih Yuo Tien, Tu-chen (TW); Yi De He, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/858,780

(22) Filed: Jun. 1, 2004

(30) Foreign Application Priority Data
May 30, 2003 (TW) 92114849

(51) Int. Cl. G06F 17/60

(52) U.S. Cl. 705/28

(57) ABSTRACT

A vendor-managed inventory system includes a VMI hub system (10), a buyer system (20), a plurality of vendor systems (30) and an external network (40) which interconnects all these systems. The VMI hub system stores and manages materials for the buyer system and the vendor systems, which can significantly reduce inventory control costs for both systems. The VMI hub system has a hub server (100) including a buyer requirements information management module (1002), an inventory information processing module (1004), an alert signal generating module (1006), a vendor delivery information management module (1008), and an inventor information updating module (1010). A related vendor-managed inventory method is also disclosed in the present invention.

### BACKGROUND OF THE INVENTION

1. Field of the Invention

The present invention relates generally to vendor-managed inventory, and especially to a vendor-managed inventory system and method for providing vendor-managed inventory services to a customer over an electronic communications network.

2. Background of the Invention

Vendor-managed inventory (VMI) is a business method which relates to vendor and customer interaction in an effort to minimize the customer's share of distribution costs and to eliminate inventory shortages associated with distributing a vendor's goods. Vendors that are able to reduce the customer's costs incurred in the purchase and distribution of the vendors' goods provide an added incentive for the customer to purchase more goods.

The art of automated vendor-managed inventory has been disclosed in patents such as U.S. Pat. Publication No. 2003023503 entitled Vendor-managed Inventory Method and System and published on Jan. 30, 2003. This patent illustrates a vendor-managed inventory system based on a network environment which comprises a vendor system, a buyer system and an external network connecting the two systems. The buyer system includes a buyer server, multiple workstations and manufacturing devices, a plurality of storage locations, and a sensor device. These entities of the buyer system are connected or linked through an internal network. Each storage location stores a small quantity of production material to be consumed by one of the manufacturing devices. The sensor device monitors quantities of materials at the storage locations via the internal network. When a quantity of any material falls below a specified threshold, the sensor device triggers an alert signal. The alert signal is then transferred to the buyer server, and material requirements information is generated and transmitted to the vendor system. Afterward, the required material is delivered to the buyer's premises by the vendor.

Although the system described above can reduce a level of stock for a buyer system, it cannot significantly lower inventory of a corresponding vendor. It is necessary that the vendor monitor a material consumption status of its customer at all times, and to have material stock on hand in order to timely supply the buyer. Therefore, the vendor is burdened with more inventory costs and management duties in controlling inventory of the supply chain. Accordingly, what is needed is an inventory system and method which can reduce inventory control costs for a buyer and its related vendors at the same time.

### SUMMARY OF THE INVENTION

A main objective of the present invention is to provide a vendor-managed inventory system and method which can reduce inventory control costs for a buyer and its vendors at the same time.

Another objective of the present invention is to provide a vendor-managed inventory system and method which can automatically generate an alert signal to notify a corresponding vendor to supply a material when a current stock of the material in the system falls below a predetermined threshold.

To accomplish the above objectives, a vendor-managed inventory (VMI) system in accordance with a preferred embodiment of the present invention comprises a VMI hub system, a buyer system, a plurality of vendor systems and an external network interconnecting all these systems. The VMI hub system can store and manage materials for the buyer system and the vendor systems. The VMI hub system comprises a hub server including: a buyer requirements information management module provided for receiving material requirements information from the buyer system, and generating a material extraction record when the VMI hub system extract a required material from its warehouses to supply the buyer system according to the material requirements information; an inventory information processing module provided for querying inventory-related records of the material, and determining whether a current stock of the material has fallen below a corresponding predetermined inventory threshold; an alert signal generating module provided for generating a second alert signal when the current stock of the material has fallen below the predetermined inventory threshold; and a vendor delivery information module provided for generating a material replenishment record to be transferred to a corresponding vendor system according to the second alert signal, and generating a delivery record after premises corresponding to the VMI hub system receives the material delivered by the vendor system.

Further, the present invention provides a preferred vendor-managed inventory method comprising the steps of: (a) receiving material requirements information from a buyer system; (b) supplying the buyer system with the required material, and generating a material extraction record; (c) updating a current stock record of the material stored in a hub database according to the material extraction record; (d) determining whether the current stock of the material has fallen below a predetermined inventory threshold; (e) generating a second alert signal if the current stock of the material has fallen below the predetermined inventory threshold; (f) receiving the second alert signal, and generating a material replenishment record to be transferred to a corresponding vendor system; (g) receiving the material delivered by the vendor system, and generating a delivery record; and (h) updating the current stock record of the material stored in the hub database in accordance with the delivery record.

Other objects, advantages and novel features of the present invention will be drawn from the following detailed description of the preferred embodiment and preferred method of the present invention with the attached drawings, in which:

### BRIEF DESCRIPTION OF THE DRAWINGS

FIG. 1 is a schematic diagram of hardware configuration of a vendor-managed inventory system in accordance with the preferred embodiment of the present invention;

FIG. 2 is a block diagram showing main function units of a hub server of the vendor-managed inventory system of FIG. 1; and

FIG. 3 is a flowchart illustrating a preferred method of implementing the vendor-managed inventory system.

### DETAILED DESCRIPTION OF THE INVENTION

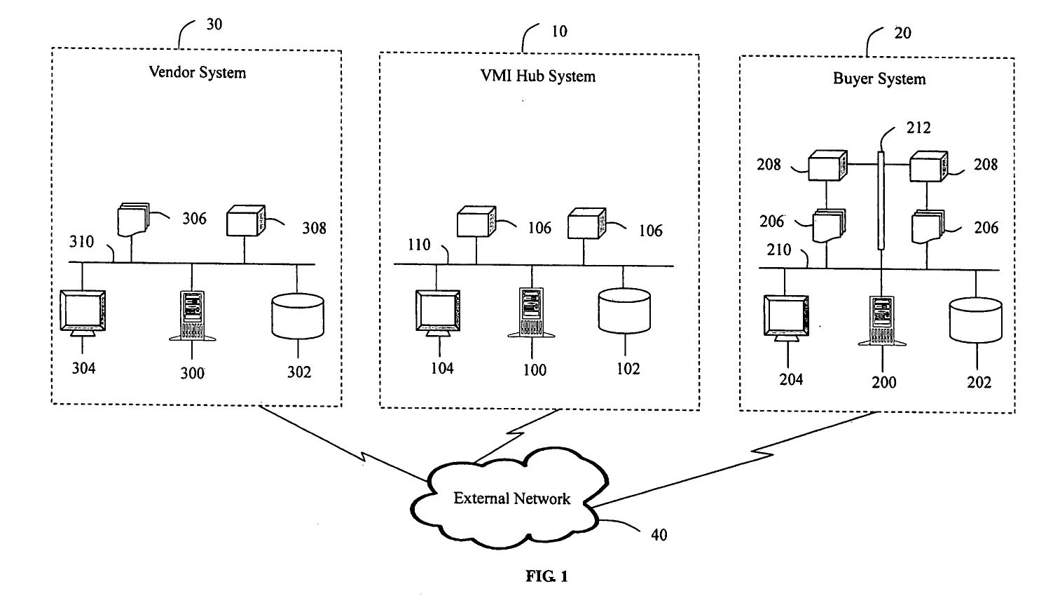

FIG. 1 is a schematic diagram of hardware configuration of a vendor-managed inventory (VMI) system in accordance with the preferred embodiment of the present invention. The vendor-managed inventory system comprises a VMI hub system 10, a buyer system 20, a plurality of vendor systems 30, and an external network 40 which interconnects all these systems. Only one vendor system 30 is shown in FIG. 1.

The VMI hub system 10 may be considered as an inventory management center for the vendor-managed inventory system of the present invention, and may partially function as a logistics center. The VMI hub system 10 can store and manage materials delivered by the vendor systems 30, receive material requirements information from the buyer system 20, and timely supply the buyer running the buyer system 20 with required materials. When a current stock of a certain material falls below a predetermined inventory threshold, the VMI hub system 10 transmits a material replenishment record to a corresponding vendor system 30 that provides such material, notifying the vendor running that vendor system 30 to supply the needed material. The material replenishment record may comprise information including a name, a quantity, specifications, and a delivery time of the material to be replenished. The predetermined inventory threshold is calculated according to business rules adopted by the VMI hub system 10 which are well known and will be appreciated by those skilled in the art. The VMI hub system 10 is generally located in hub premises that are near the buyer, in order to timely deliver required materials to the buyer.

The VMI hub system 10 comprises a hub server 100, a hub database 102, a plurality of hub workstations 104 (only one shown), a plurality of hub warehouses 106 (only one shown), and a network 10 interconnecting all the above entities. The hub server 100 may execute various software applications to enable entities of the VMI hub system 10 to communicate with each other as well as perform various enterprise level tasks. Such tasks may include receiving material requirements information from the buyer system 20, and transmitting material replenishment records to the vendor systems 30. The software applications that can be executed by the hub server 100 include enterprise resource planning software, email software, database management software, and other tools commonly used in a business environment. The hub database 102 stores records used or generated by the VMI hub system 10, especially inventory-related records. The inventory-related records may include current stock records of various materials, material requirements information from the buyer system 20, material extraction records, and material replenishment records transferred to the vendor systems 30. A material extraction record is generated when the VMI hub system 10 extracts a material from one of the hub warehouses 106 to supply the buyer system 20. The material extraction record comprises a name, specifications, an extraction quantity, and a time of the extraction.

The hub workstations 104 may be general-purpose computer devices such as personal computers, laptops, portable handheld devices (e.g., personal digital assistants—PDAs), or other suitable devices known in the art. Each hub workstation 104 provides an interactive user interface for users of the VMI hub system 10 to carry out inventory management operations. The hub warehouses 106 store materials delivered by the vendor systems 30, in order to timely supply the buyer system 20 with required materials. The network 110 may be any suitable communications architecture required by the VMI hub system 10, such as a local area network, wide area network, etc.

The buyer system 20 is typically a manufacturing plant or facility which consumes production materials stored in the VMI hub system 10, and comprises a buyer server 200, a buyer database 202, multiple buyer workstations 204 (only one shown), multiple buyer production devices 206, multiple supply containers 208, an alert device 212 and a network 210 interconnecting all the above entities. The buyer server 200 may execute one or more computer programs to enable the entities of the buyer system 20 to communicate with each other, as well as perform various enterprise level tasks such as transferring material requirements information to the VMI hub system 10. Typical computer programs that may be executed by the buyer server 200 include those for Materials Requirements Planning (MRP), Enterprise Resource Planning (ERP), billing, finance, and security.

The buyer database 202 stores records used or generated by the buyer system 20, especially material requirements information. The buyer workstations 204 may be general-purpose computer devices such as personal computers, laptops, portable handheld devices, or other suitable computer processing devices. Each buyer workstation 204 provides an interactive user interface for users of the buyer system 20 to carry out inventory management operations. The buyer production devices 206 represent manufacturing or production machinery for producing products needed by customers. The supply containers 208 are located near the buyer production devices 206. Each supply container 208 stores a certain quantity of material to be consumed or expended by a corresponding buyer production device 206. The alert device 212 is connected to the supply containers 208 for monitoring and measuring the contents of production materials therein. When a quantity of a material stored in any of the supply containers 208 falls below a predetermined inventory threshold, the alert device 212 generates a first alert signal. The first alert signal is transferred to the buyer server 200, and indicates that the material is running out and needs to be restocked. The predetermined inventory threshold is customarily determined by the buyer system 20 according to its own production planning, and the supply capacity and speed of the VMI hub system 10. Although only one alert device 212 is shown, the buyer system 20 may alternatively be configured to include a plurality of alert devices 212 as required. The network 210 may be any suitable communications network needed by the buyer system 20, such as a local area network, wide area network, etc.

Each vendor system 30 comprises a vendor server 300, a vendor database 302, a plurality of vendor workstations 304 (only one shown), a plurality of vendor production devices 306, a plurality of storage locations 308 (only one shown), and a network 310 interconnecting all the above entities. The vendor server 300 may execute one or more computer programs to enable the entities of the vendor system 30 to communicate with each other, as well as perform various enterprise level tasks such as receiving material replenishment records from the VMI hub system 10. The vendor database 302 stores records used or generated by the vendor system 30, especially material replenishment records received from the VMI hub system 10, data on materials shipped to the hub premises, and current stocks of materials in the storage locations 308. The vendor workstations 304 may be general-purpose computer devices such as personal computers, laptops, portable handheld devices, or other suitable computer processing devices. Each vendor workstation 304 provides an interactive user interface for users of the vendor system 30 to carry out inventory management operations. The vendor production devices 306 represent manufacturing or production machinery for producing materials needed by the buyer system 20. The storage locations 308 store materials manufactured by the vendor production devices 306. The network 310 may be any suitable communications network needed for the vendor system 30, such as a local area network, wide area network, etc.

The VMI hub system 10, the buyer system 20 and the vendor systems 30 communicate with each other via the external network 40. The external network 40 may be any appropriate high-speed communications network known in the art, such as a private network or the Internet, and may include wireless technology and devices.

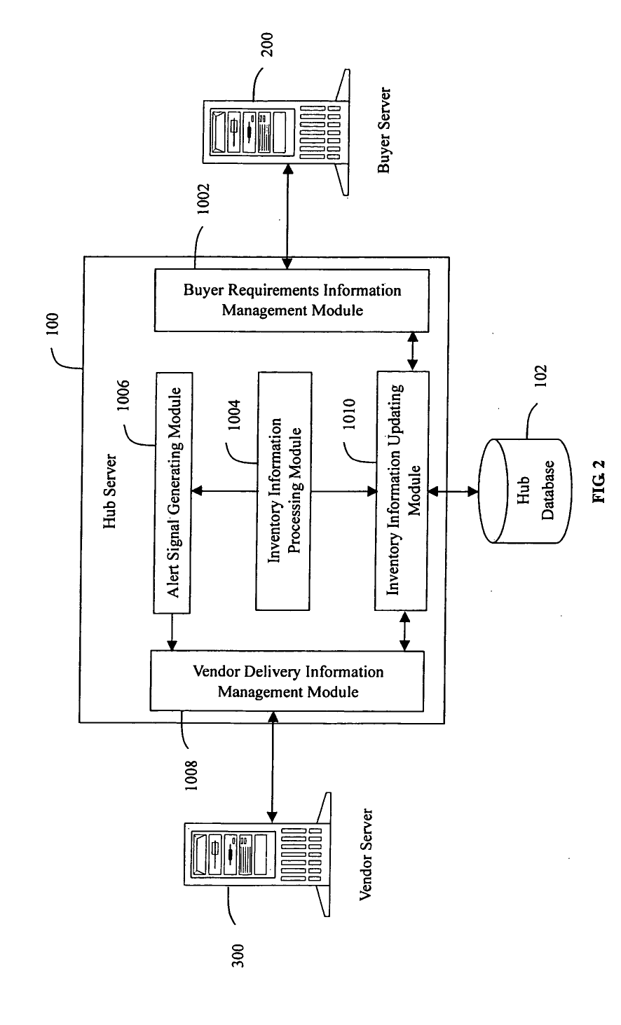

FIG. 2 is a block diagram showing main function units of the hub server 100. The hub server 100 comprises a buyer requirements information management module 1002, an inventory information processing module 1004, an alert signal generating module 1006, a vendor delivery information management module 1008, and an inventory information updating module 1010.

The buyer requirements information management module 1002 is provided for receiving material requirements information from the buyer server 200, and generating a material extraction record when the VMI hub system 10 extracts a required material from one of the hub warehouses 106 according to the material requirements information. The inventory information processing module 1004 is provided for searching inventory-related records of the material in the hub database 102, and determining whether a current stock of the material has fallen below a corresponding predetermined inventory threshold. The alert signal generating module 1006 is provided for generating a second alert signal when the current stock of the material is below the predetermined inventory threshold. The vendor delivery information module 1008 is provided for generating a material replenishment record to be transferred to a corresponding vendor system 30 according to the second alert signal, and generating a delivery record after the hub premises receives the material delivered by the vendor. The delivery record may include a name, specifications, a quantity of the material, and a time when the material is delivered. The inventory information updating module 1010 is provided for updating the current stock record of the material stored in the hub database 102 according to the material extraction record and the delivery record.

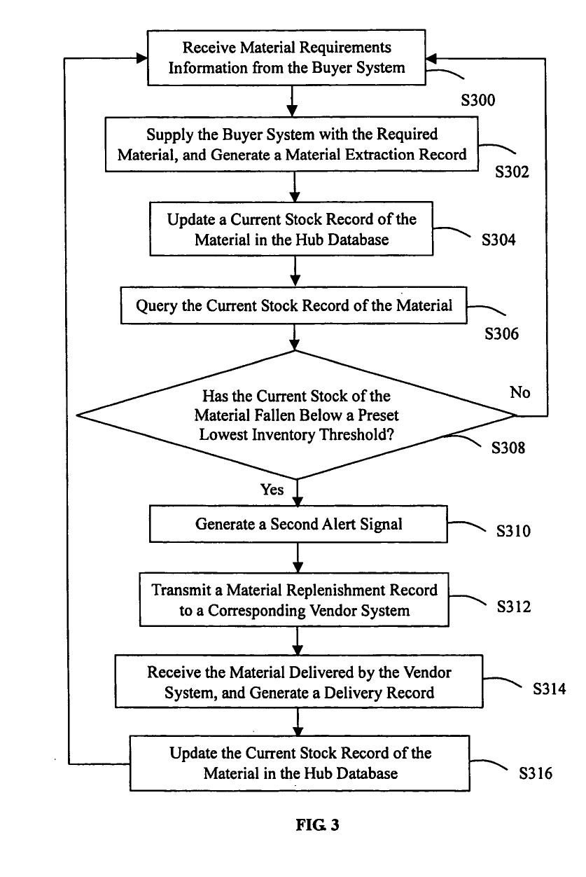

FIG. 3 is a flowchart illustrating a preferred method of implementing the vendor-managed inventory system. In the buyer system 20, the buyer production devices 206 continuously consume production materials in the supply containers 208. In step S300, once a current stock of a material in any of the supply containers 208 falls below its predetermined inventory threshold, the alert device 212 monitoring the contents of the supply containers 208 generates a first alert signal that is transmitted to the buyer server 200. The buyer server 200 then sends material requirements information to the hub server 100 through the external network 40, requiring the VMI hub system 10 to supply the material. The material requirements information is received by the buyer requirements information management module 1002, and stored in the hub database 102.

Then, in step S302, the buyer requirements information management module 1002 notifies operators located at the hub workstations 204 through the network 110 to extract the material from one or more of the hub warehouses 106 according to the material requirements information, and generates a material extraction record to be stored in the hub database 102. In step S304, the inventory information updating module 1010 updates the current stock record of the material stored in the hub database 102 according to the material extraction record. Afterward, in step S306, the inventory information processing module 1004 searches in the hub database 102 for the updated current stock record of the material. In step S308, the inventory information processing module 1004 compares the updated current stock record and a corresponding predetermined inventory threshold, and determines whether the current stock of the material has fallen below the predetermined inventory threshold.

If the current stock is above or equal to the predetermined inventory threshold, the procedure returns to step S300, with the hub server 100 waiting to receive a next transmission of material requirements information. If the current stock is below the predetermined inventory threshold, in step S310, the alert signal generating module 1006 automatically creates a second alert signal indicating that the material needs to be replenished, and transmits the second alert signal to the vendor delivery information management module 1008. In step S312, the vendor delivery information management module 1008 receives the second alert signal, and generates a material replenishment record that is transmitted to the vendor server 300. The vendor server 300 notifies operators located at the vendor workstations 304 to deliver the material according to the material replenishment record. In step S314, the vendor delivery information management module 1008 generates a delivery record after the hub premises receives and accepts the delivered material. In step S316, the inventory information updating module 1010 updates the current stock record of the material stored in the hub database 102 according to the delivery record, whereupon the procedure returns to step S300.

Although the present invention has been specifically described on the basis of a preferred embodiment and preferred method, the invention is not to be construed as being limited thereto. Various changes or modifications may be made to said embodiment and method without departing from the scope and spirit of the invention.

What is claimed is:

1. A vendor-managed inventory (VMI) system for providing vendor-managed inventory services over a network environment, the system comprising a VMI hub system, a buyer system, a plurality of vendor systems and an external network interconnecting said comprised systems, wherein the VMI hub system comprises a hub server to enable entities of the VMI hub system to communicate with each other as well as perform various enterprise level tasks, the hub server comprising:
a buyer requirements information management module provided for receiving material requirements information from the buyer system, and generating a material extraction record when the VMI hub system extracts a required material from its warehouses to supply the buyer system according to the material requirements information;
an inventory information processing module provided for querying inventory-related records of the material, and determining whether a current stock of the material has fallen below a corresponding predetermined inventory threshold;
an alert signal generating module provided for generating a second alert signal when the current stock of the material has fallen below the predetermined inventory threshold; and
a vendor delivery information module provided for generating a material replenishment record to be transferred to a corresponding vendor system according to the second alert signal, and generating a delivery record after premises corresponding to the VMI hub system receives the material delivered by the vendor.

2. The system according to claim 1, wherein the hub server further comprises an inventory information updating module provided for updating the current stock record of the material according to the material extraction record and the delivery record.

3. The system according to claim 1, wherein the VMI hub system further comprises a hub database for storing records used or generated by the VMI hub system.

4. The system according to claim 1, wherein the VMI hub system further comprises a plurality of hub workstations, each of the hub workstations providing an interactive user interface for users of the VMI hub system to carry out inventory management operations.

5. The system according to claim 1, wherein the VMI hub system further comprises a plurality of hub warehouses provided for storing materials delivered by the vendor systems in order to timely supply the buyer system with required materials.

6. The system according to claim 1, wherein the buyer system comprises an alert device provided for monitoring and measuring quantities of materials in the buyer system, and for generating a first alert signal when a quantity of any material falls below a respective predetermined inventory threshold.

7. The system according to claim 6, wherein the predetermined inventory threshold is determined by the buyer system according to its own production planning and the supply capacity and speed of the VMI hub system.

8. The system according to claim 6, wherein the buyer system further comprises a buyer server provided for receiving the first alert signal and transmitting material requirements information to the VMI hub system.

9. The system according to claim 1, wherein each of the vendor systems comprises a vendor server provided for enabling entities of the vendor system to communicate with each other, and for receiving the material replenishment record from the VMI hub system.

10. A computer-based vendor-managed inventory method comprising the steps of:
receiving material requirements information from a buyer system;
supplying the buyer system with the required material, and generating a material extraction record;
updating a current stock record of the material stored in a hub database according to the material extraction record; and
determining whether the current stock of the material has fallen below a predetermined inventory threshold;
and if the current stock of the material has fallen below the predetermined inventory threshold:
generating a second alert signal;
receiving the second alert signal, and generating a material replenishment record to be transferred to a corresponding vendor system;
receiving the material delivered by the vendor system, and generating a delivery record; and
updating the current stock record of the material stored in the hub database in accordance with the delivery record.

11. The method according to claim 10, wherein the step of receiving material requirements information comprises:
generating a first alert signal when a quantity of a material of the buyer system falls below a predetermined inventory threshold;
receiving the first alert signal, and generating material requirements information; and
transmitting the material requirements information to the VMI hub system.
